(19) United States
(12) Patent Application Publication
(10) Pub. No.: US 2018/0080573 A1
(43) Pub. Date: Mar. 22, 2018

(54) ACTUATOR

(71) Applicant: Johnson Electric S.A., Murten (CH)

(72) Inventor: Yvan BOURQUI, Corminboeuf (CH)

(21) Appl. No.: 15/710,282

(22) Filed: Sep. 20, 2017

(30) Foreign Application Priority Data
Sep. 20, 2016 (GB) 1615968.3

(51) Int. Cl. F16K 31/04

(52) U.S. Cl. CPC F16K 31/047; H02K 5/15

(57) ABSTRACT

An actuator includes an electric motor and an actuator housing accommodating the electric motor. The electric motor includes a stator and a rotor. The stator includes: a bobbin having a rotor receiving portion rotatably receiving the rotor, and a plurality of winding supporting portions extending from the rotor receiving portion; a plurality of stator winding respectively mounted on the winding supporting portions; and a plurality of core lamination units engagable with the winding supporting portions. The actuator housing includes a plurality of motor supports integrally formed in the actuator housing. The motor supports directly engaged the stator to support the electric motor inside the actuator housing.

### CROSS REFERENCE TO RELATED APPLICATIONS

This non-provisional patent application claims priority under 35 U.S.C. § 119(a) from Patent Application No. 1615968.3 filed in United Kingdom on Sep. 20, 2016.

### FIELD OF THE INVENTION

The present invention relates to an actuator, preferably but not necessarily exclusively a stepper actuator for use in automotive contexts.

### BACKGROUND OF THE INVENTION

One of the most important features of an electric actuator, particularly in automotive contexts, is its overall size, be its volume or the footprint of the actuator in two dimensions. Where footprint is the more critical variable, often the internal components of the electric actuator can be stacked in a vertical direction in order to ensure optimum overlap between the components, typically by stacking the electric motor and the gear train.

Typically, a cylindrical stepper motor is provided in an actuator, and this requires a set amount of space upon which it can be securely seated inside the actuator housing. When the electric motor and gear train are stacked, a separation plate is installed into the actuator housing which is complementarily engagable with the actuator housing. The electric motor can be seated on one side of the separation plate, and the gear train can be seated on the other, providing secure mounting to each; without this separation plate, either the gear train or the electric motor would not be secure in position.

The separation plate increases the overall bulk of the actuator, since it fills valuable internal space inside the actuator housing, and also increases the complexity of assembly of the actuator, as a greater number of components must be interengaged.

### SUMMARY OF THE INVENTION

The present invention seeks to provide a solution to these problems by providing an actuator in which the separation plate can be eliminated, thereby providing a more compact actuator arrangement.

According to a first aspect of the invention, there is provided an actuator including an electric motor and an actuator housing accommodating the electric motor. The electric motor includes a stator and a rotor. The stator includes: a bobbin having a rotor receiving portion rotatably receiving the rotor, and a plurality of winding supporting portions extending from the rotor receiving portion; a plurality of stator winding respectively mounted on the winding supporting portions; and a plurality of core lamination units engagable with the winding supporting portions. The actuator housing includes a plurality of motor supports integrally formed in the actuator housing. The motor supports directly engaged the stator to support the electric motor inside the actuator housing.

By providing a plurality of motor supports as part of the actuator housing of the actuator upon which the electric motor can be seated, the motor-support plate which is traditionally required for a stepper actuator can be eliminated from the assembly. This results in a more compact actuator than that achievable with traditional designs, whilst reducing the complexity of the assembly and reducing the number of components which must be manufactured in order to produce the actuator.

Preferably, the actuator housing may be a two-part enclosure having first and second housing portions, the plurality of motor supports being provided in one or other of the first and second housing portion. Furthermore, the plurality of motor supports may be integrally formed with the actuator housing.

The provision of the two-part housing greatly simplifies the construction of the actuator; the gear train and electric motor can be inserted into one part of actuator housing and be secured positionally, before the other part of the actuator housing is engaged so as to enclose the actuator. This ensures a simple assembly process, reducing the time taken to assemble the actuator.

In one preferred embodiment, each of the plurality of winding supporting portions may comprise a member body which extends from the rotor receiving portion and an end cap at a distal end of the member body, the stator winding being mountable about the member body. Each end cap may be complementarily engagable with a motor support, and/or the member body may include a receiving aperture therethrough within which at least part of the core lamination unit is receivable.

The form of the bobbin may advantageously provide a number of distinct mounting points on the electric motor which can readily engage with the actuator housing and be supported thereby. The winding supporting portions provide a readily accessible point of contact via the end caps for this purpose.

Preferably, the plurality of winding supporting portions may be angularly equipositioned about the rotor receiving portion. Optionally, the stator may be provided as a plurality of core lamination units which are respectively engagable with the plurality of winding supporting portions, in which case four said winding supporting portions may be provided, each winding supporting portion being engagable with one of the plurality of motor supports.

A star motor is an advantageous motor arrangement for this particular actuator, since there will be a plurality of discrete points on the bobbin which can be engaged with the supports on the actuator housing.

The actuator may further comprise an electrical connector engaged with the bobbin. Said electrical connector may be spaced apart from the rotor receiving portion along an axis of rotation of the rotor, and, additionally or alternatively, the electrical connector may be positioned at a distalmost end of one of the plurality of winding supporting portions relative to the rotor receiving portion. The electrical connector may project beyond the core lamination unit when engaged with the said winding supporting portion. Preferably, the electrical connector may be complementarily engagable with a motor support.

The electrical connector not only provides a ready way of connecting the electric motor to an external power supply or controller through the actuator housing, but can also advantageously also act as a vertically displaced support inside the actuator housing, which may make the installation of various components around the electric motor more straightforward.

Optionally, there may be provided at least one output gear mountable within the actuator housing. Preferably, at least one of the plurality of motor supports is provided as an elongate member extended from an internal surface of the actuator housing. The provision of a projecting elongate member inside the actuator housing upon which the electric motor is seatable advantageously aids with the three-dimensional positioning of the electric motor inside the actuator housing, potentially acting as a spacer so as to allow for additional components to be incorporated therein without significantly increasing a size of the actuator as a whole. One example of such a component might be the output gear of the actuator, which must be positioned on a particular side of the electric motor in order to operate.

According to a second aspect of the invention, there is provided an actuator comprising: an electric motor having a bobbin having a rotor receiving portion and a stator support at or adjacent to the rotor receiving portion; a rotor receivably mountable at the rotor receiving portion; a stator which is engagable with the stator support; and at least one stator winding mountable about the bobbin; and an actuator housing having a plurality of motor supports which is directly engagable with the bobbin and/or stator to support the electric motor inside the actuator housing. Preferably, the actuator may further comprise an electrical connector engaged with the bobbin, wherein the electrical connector is directly engagable with one of the plurality of motor supports.

Whilst the provision of an actuator having a star motor may most advantageously be seatable in an actuator housing without the need to provide a motor-support plate, it will be appreciated that a means by which other motor types can be supported inside the actuator housing could be provided, particularly in the case where an integrally formed electrical connector is provided on the bobbin.

The provision of an actuator housing which can be assembled without a motor-support plate advantageously reduces the complexity of the assembly of the actuator and reduces the number of components which must be manufactured, whilst still resulting in a compact assembled actuator arrangement.

The invention will now be more particularly described, with reference to the accompanying drawings, in which:

### BRIEF DESCRIPTION OF THE DRAWINGS

FIG. 1 shows a perspective representation of one embodiment of an actuator in accordance with the first aspect of the invention, the actuator housing being transparent to illustrate the inner components of the actuator;

FIG. 2 shows a plan view of the actuator of FIG. 1;

FIG. 3 shows an exploded perspective representation from the side of the actuator of FIG. 1; and

FIG. 4 shows a perspective representation of the actuator of FIG. 1, with the upper housing portion and gear train omitted for clarity.

### DETAILED DESCRIPTION OF THE PREFERRED EMBODIMENTS

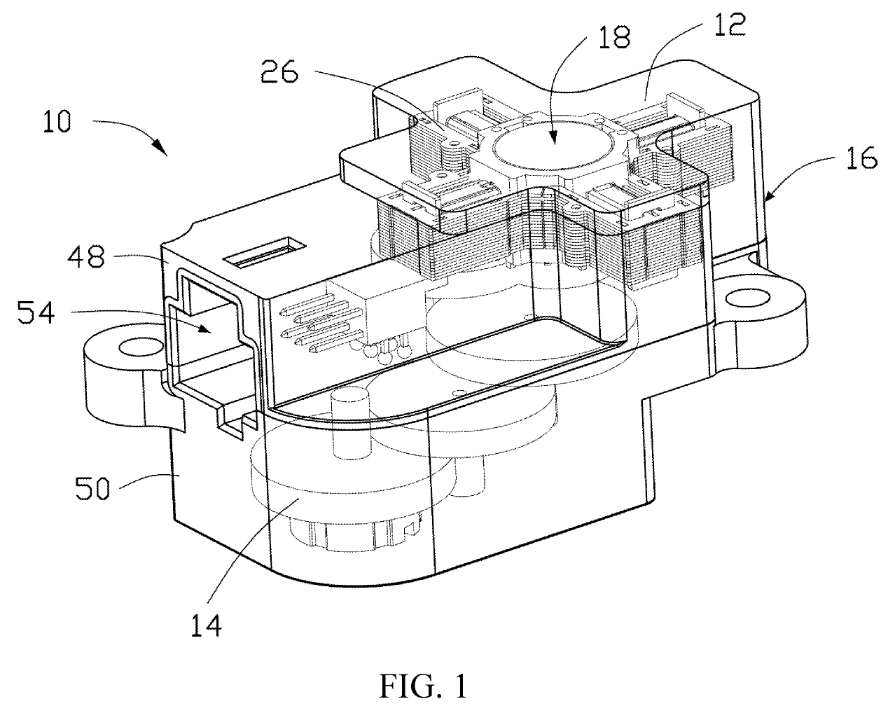

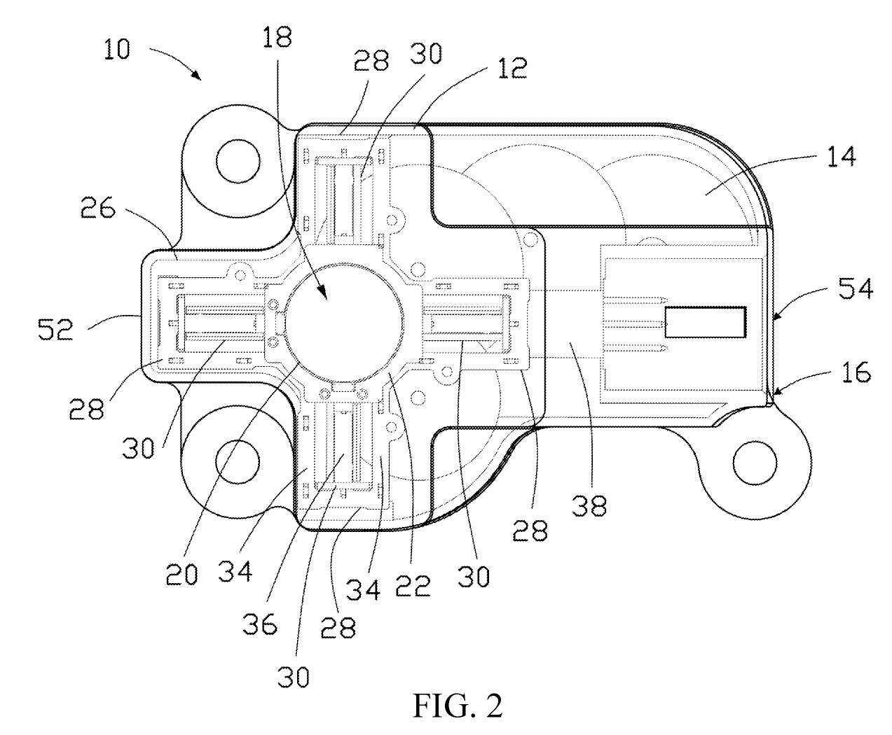

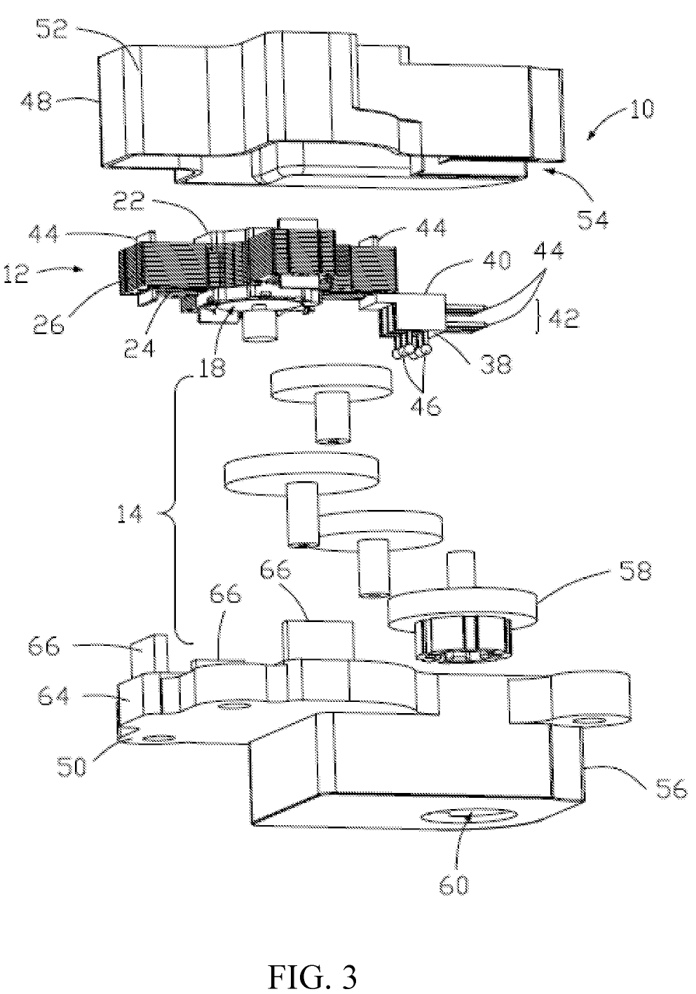

Referring to FIGS. 1 to 3, there is provided an actuator, indicated globally at 10, which is preferably provided as a stepper actuator suitable for use in an automotive context, for example, as part of a heating, ventilation and air conditioning (HVAC) system.

The stepper actuator 10 comprises an electric motor 12 and a gear train 14 which are enclosed within an actuator housing 16. In the present arrangement, at least some of the individual gears of the gear train 14 are oriented such that their footprint overlaps with that of the electric motor 12 when installed into the actuator housing 16.

The electric motor 12 is here formed as a star motor having a central rotor 18 and a stator 26 mounted around the rotor 18. The stator 26 includes a bobbin 22, plurality of stator windings 24, and a plurality of core lamination units 28. The bobbin 22 includes a receiving portion 20, in which the rotor 18 is rotatably received, and a plurality of winding supporting portions 30 which extend radially from receiving portion 20, on which, the stator windings 24 are respectively wound. In the depicted embodiment, four such winding supporting portions 30 are shown. The core lamination units 28 are engagable with the bobbin 22 and respectively adjacent to stator windings 24. It will be appreciated that the core lamination units 28 could be constructed as a unitary part, which might be achieved by having a multi-part bobbin, and therefore the depicted arrangement is for indicative purposes only.

Each winding supporting portion 30 comprises a, preferably elongate, member body, which extends radially away from the rotor 18 and terminates at an end cap 32. The end cap 32 extends proud of the member body in a lateral direction, at least in part, so as to define a shoulder relative to an outer surface of the member body. The stator windings 24 can be wound around the outer surface of each winding supporting portion 30, the end caps 32 preventing the stator windings 24 from sliding off the outer surface of the winding supporting portions 30.

In the depicted embodiment, each of the member bodies is formed from two parallel spaced apart body portions, which, in conjunction with a receiving aperture in the associated end cap 32, defines a core lamination unit receptacle in the member body.

Each core lamination unit 28 has three conjoined arms: two outer stator arms 34, an end of each outer stator arm 34 preferably being formed so as to match a curvature of the bobbin 22 which is adjacent the rotor 18; and a central stator arm 36 which is receivable within the core lamination unit receptacle to retain the core lamination unit 28 in position on its respective winding supporting portion 30.

On one of the winding supporting portions 30 there may preferably be provided an electrical connector 38, which has a connector body 40 and at least one electrically conductive element 42 extending therefrom. Here, the electrical connector 38 is formed as a male engagement connector, wherein the electrically-conductive elements 42 are formed as six projecting pins 44 which extend through the connector body 40 into corresponding connector terminals 46. Any appropriate form of electrical connector may be provided, of course, including female engagement connectors.

The electrical connector 38 may preferably be integrally formed with the bobbin 22, in this case extending from an end cap 32 of the winding supporting portion 30 to which it is attached. The electrical connector 38 is spaced apart from the rotor 18 not only in the plane of the winding supporting portions 30, but also in a direction parallel to the rotational axis of the rotor 18. This increases the height of the bobbin 24.

That the electrical connector 38 sits proud of the receiving aperture allows the core lamination unit 28 engagable with the corresponding winding supporting portion 30 to be engaged therewith without difficulty. The electrical connector 38 may also project beyond the distalmost portion of the end cap 32 in a longitudinal direction of the winding supporting portion 30, for example, with the pins 44 projecting outwardly from the end cap 32 to give the bobbin 22 an overall elongate cruciform profile, when viewed from above.

The actuator housing 16 is preferably formed as a two-part housing, having first and second, preferably upper and lower, housing portions 48, 50 which are complementarily interengagable. The first housing portion 48 is formed so as to receive the electric motor, here having a substantially cruciform body region 52 and a connector access port 54 which, when assembled, is aligned to the electrical connector 38 so as to permit onward electrical connection of the electric motor 12 to, for example, a power supply and/or control electronics.

The second housing portion 50 is here formed having a deep body region 56, within which at least an output gear 58 of the gear train 14 is seatable, the deep body region 56 an access aperture 60 through which the output gear 58 may project. This deep body region 56 may be seated at or adjacent to the connector access port 54 of the first housing portion 48, once assembled, and may have at least one plate-like portion 62 of the connector access port 54 formed, preferably integrally so, therein.

The second housing portion 50 may also include a shallow body region 64 which is adjacent to the deep body region 56 and is adapted to receive the electric motor 12. In the depicted embodiment, there is a plurality of elongate members 66 which project out of the shallow body region 64, preferably at or adjacent to a perimeter of the second housing portion 50. The elongate members 66 are preferably integrally formed as part of the second housing portion 50, but could feasibly be releasably engagable with the second housing portion 50, if this would simplify the manufacture and/or assembly of 30 the actuator 10.

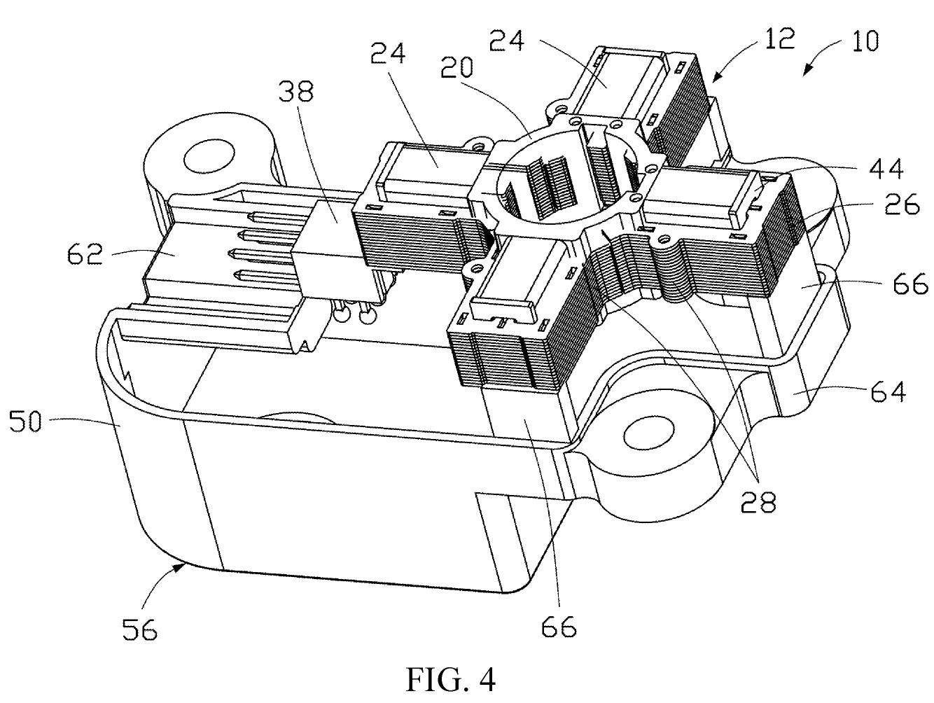

The present invention utilizes the actuator housing 16 as a direct support for the electric motor 12 and the gear train 14, without requiring the use of a motor-support plate. The insertion of the electric motor 12 into the second housing portion 50 of the actuator housing 16 is shown in FIG. 4.

The electric motor 12 is directly 5 mountable onto a plurality of motor supports, preferably by direct contact with the bobbin 22 and/or the core lamination units 28, such that the motor-support plate can be dispensed with.

In the depicted embodiment, each of the projecting elongate members 66 is aligned so as to contact with the electric motor 12 at or adjacent to the ends of corresponding stator 10 engagement members 30. This may preferably be achieved by the projection of the end caps 32 of the winding supporting portions 30 proud of the engaged core lamination units 28 to form a lip or shoulder which can rest or engage with a distalmost end of corresponding elongate members 66 to support the electric motor 12 in position.

Furthermore, the electrical connector 38 may also engage with a separate support of the second housing portion 50. In this instance, the connector body 40 of the electrical connector 38 may be seatable on the plate-like portion 62 of the connector access port 54, so as to provide a support which is vertically spaced-apart from the corresponding points of contact on the elongate members 66.

To assemble the actuator 10, the gear train 14 can be inserted into the actuator housing 16 so as to be rotationally operable, and there may be pre-formed seats within the actuator housing 16 which define positions for the gears of the gear train 14.

Once the gears have been installed into the actuator housing 16, the electric motor 12, preferably having been preassembled, can be inserted into the actuator housing 16. This can be achieved by seating the electrical connector 38 so as to abut or otherwise engage with the plate like portion 62 of the connector access port 54, and by seating the bobbin 22 and/or core lamination units 28 onto the elongate members 66, thereby supporting the electric motor 12 directly on the actuator housing 16 at a plurality of different support locations, here there being four such supports. Preferably the supports correspond with the number and positions of the winding supporting portions 30.

This assembly is preferably completed in the second housing portion 50 only, which then allows the first housing portion 48 to be receivably engaged with the second housing portion 50 to seal the actuator housing 16, forming a complete and unitary actuator 10. This sealing may be releasable or otherwise; preferably the first and second housing portions 48, 50 will be irreversibly connected, for example using adhesive and/or by welding the two portions to one another.

The actuator 10 formed is therefore a compact unit, having all of the relevant components sealed inside in position, with an electrical input at the connector access port 54 and a drive output at the access aperture 60 for onward connection of drive of the actuator. The actuator 10 is comparatively straightforward to assemble, requiring fewer materials and components in order to complete the assembly than a traditional actuator arrangement.

Whilst the above invention has been described in the context of a star motor, it will be appreciated that the concept could be extended to other forms of motors, if suitable supports in the actuator housing are provided which can abut or otherwise engage with at least part of an electric motor inserted into the actuator housing. For example, a cylindrical motor having a stator with engagement regions could conceivably be provided.

It is also noted that whilst the gear train is described as being installed into the actuator housing prior to the electric motor in the above embodiment, the order of installation could readily be reversed, and this may be dependent upon the construction of the actuator housing.

It is therefore possible to provide an actuator which houses an electric motor and a gear train without the need to provide a separate motor-support or separation plate. This is achieved by providing one or more supports from which the electric motor can be mounted directly to the actuator housing to both reduce the complexity of assembly and the number of components required to produce an actuator.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features 5 of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. An actuator comprising:
an electric motor comprising a rotor and a stator:
the stator comprising:
a bobbin having a rotor receiving portion rotatably receiving the rotor, and a plurality of winding supporting portions extending from the rotor receiving portion;
a plurality of stator winding respectively mounted on the winding supporting portions; and
a plurality of core lamination units engaged with the plurality of winding supporting portions corresponding to the plurality of winding; and
an actuator housing having a plurality of motor supports integrally formed in the actuator housing, the motor supports directly engaged the stator to support the electric motor inside the actuator housing.

2. The actuator as claimed in claim 1, wherein the actuator housing is a two-part enclosure having first and second housing portions, the plurality of motor supports being provided in one of the first and second housing portions.

3. The actuator as claimed in claim 1, wherein each of the plurality of winding supporting portions comprises a member body which extends from the rotor receiving portion and an end cap at a distal end of the member body, the stator winding being mountable about the member body.

4. The actuator as claimed in in claim 1, wherein the winding supporting portions are angularly equi-positioned about the rotor receiving portion.

5. The actuator as claimed in claim 1, wherein the stator further comprises an electrical connector engaged with the bobbin, one of the motor supports directly supports the electrical connector.

6. The actuator as claimed in claim 5, wherein the electrical connector is spaced apart from the rotor receiving portion along an axis of rotation of the rotor.

7. The actuator as claimed in claim 5, wherein the electrical connector is positioned at a distalmost end of one of the plurality of winding supporting portions relative to the rotor receiving portion.

8. The actuator as claimed in claim 5, wherein the electrical connector projects beyond corresponding one of the core lamination units engaged with the said one winding supporting portion.

9. The actuator as claimed in claim 5, wherein the said one of the motor supports is a plate-like portion extending from a side of the actuator housing.

10. The actuator as claimed in claim 1, further comprising at least one output gear mountable within the actuator housing.

11. The actuator as claimed in claim 1, wherein at least one of the plurality of motor supports is provided as an elongate member extended from an internal surface of the actuator housing.

12. The actuator as claimed in claim 1, wherein the motor supports are discontinuously distributed in the actuator housing.
